(19) United States
(12) Patent Application Publication
(10) Pub. No.: US 2026/0369554 A1
(43) Pub. Date: Nov. 19, 2026

(54) LITHIUM-ION SECONDARY BATTERY CATHODE

(71) Applicant: TOYOTA JIDOSHA KABUSHIKI KAISHA, Toyota-shi (JP)

(72) Inventor: Ryosuke OHSAWA, Okazaki-shi (JP)

(73) Assignee: TOYOTA JIDOSHA KABUSHIKI KAISHA, Toyota-shi (JP)

(21) Appl. No.: 19/550,677

(22) Filed: Feb. 26, 2026

(30) Foreign Application Priority Data
May 16, 2025 (JP) 2025-082778

(51) Int. Cl. H01M 4/36; C01G 53/504; C01G 53/506; H01M 4/525; H01M 10/0525; H01M 4/02

(52) U.S. Cl. CPC H01M 4/364; C01G 53/504; C01G 53/506; H01M 4/525; H01M 10/0525; C01P 2002/50; C01P 2004/82; C01P 2006/40; H01M 2004/021; H01M 2004/028

(57) ABSTRACT

A lithium-ion secondary battery cathode includes a first lithium nickel composite oxide and a second lithium nickel composite oxide. A nickel composition ratio of the first lithium nickel composite oxide is higher than a nickel composition ratio of the second lithium nickel composite oxide. The first lithium nickel composite oxide includes first large particles and first small particles. The second lithium nickel composite oxide includes second large particles and second small particles. Relations of "H1 < H2", "h1 < h2", "H1 < h1" and "H2 < h2" are satisfied. "H1" indicates a hardness of the first large particles. "h1" indicates a hardness of the first small particles. "H2" indicates a hardness of the second large particles. "h2" indicates a hardness of the second small particles.

### CROSS-REFERENCE TO RELATED APPLICATION

This application claims priority to Japanese Patent Application No. 2025-082778 filed on May 16, 2025. The disclosure of the above-identified application, including the specification, drawings, and claims, is incorporated by reference herein in its entirety.

### BACKGROUND

### 1. Technical Field

The present disclosure relates to a lithium-ion secondary battery cathode.

### 2. Description of Related Art

Chinese Unexamined Patent Application Publication No. 116565133 discloses a mixture of first cathode active material particles (LiNi_{0.8}Co_{0.1}Mn_{0.1}O₂, 11.5 μm) and second cathode active material particles (LiNi_{0.82}Co_{0.135}Mn_{0.045}O₂, 5.5 μm).

### SUMMARY

In order to increase energy density of a lithium-ion secondary battery cathode (hereinafter may be abbreviated to "cathode"), a mixture of large particles and small particles, and also a mixture of two active materials with different compositions, and so forth, have been proposed. However, there is room for improvement in capacity retention rate following cycling.

An object of the present disclosure is to improve capacity retention rate following cycling.

A technical configuration of the present disclosure, and functions and effects thereof, will be described below. Note that mechanisms of action include speculation. The mechanisms of action do not limit the technical scope of the present disclosure.

1. A lithium-ion secondary battery cathode according to one aspect of the present disclosure includes a first lithium nickel composite oxide and a second lithium nickel composite oxide. A nickel composition ratio of the first lithium nickel composite oxide is higher than a nickel composition ratio of the second lithium nickel composite oxide. The first lithium nickel composite oxide includes first large particles and first small particles. The second lithium nickel composite oxide includes second large particles and second small particles. Relations of "H1 < H2", "h1 < h2", "H1 < h1" and "H2 <h2" are satisfied. "H1" indicates a hardness of the first large particles. "h1" indicates a hardness of the first small particles. "H2" indicates a hardness of the second large particles. "h2" indicates a hardness of the second small particles.

Generally, the cathode is subjected to pressing. A cathode active material may be secondary particles. The softer the secondary particles are, the more likely particle cracking, pulverization, or the like, is to occur during press working. It is thought that the finer the particles are pulverized, the greater the reaction area will be.

The cathode according to the present disclosure includes two types of active materials (lithium nickel composite oxides) having Ni composition ratios that are different from each other. The two types of active materials differ with respect to the Ni composition ratio and accordingly are thought to differ in reactivity with Li as well. The two types of the active materials each include large particles and small particles. It is thought that large particles and small particles have different reactivities due to, for example, different specific surface areas.

According to new findings in the present disclosure, improvement in capacity retention rate is anticipated when there is a combination of "large particles being more susceptible to cracking than small particles" and also "higher Ni composition ratios being more susceptible to cracking". This is presumably because the particles tend to be densely packed in the pressed electrode and also the reactivity of the two types of the active materials is well balanced.

2. The lithium-ion secondary battery cathode according to the above item "1" may include, for example, a configuration in which a relation of "d1 < d2 < D1 ≤ D2" is satisfied. "D1" indicates a mean volume diameter of the first large particles. "d1" indicates a mean volume diameter of the first small particles. "D2" indicates a mean volume diameter of the second large particles. "d2" indicates a mean volume diameter of the second small particles.

When the relation of "d1 < d2 < D1 ≤ D2" is satisfied, an improvement in the capacity retention rate is anticipated. This is thought to be because the reactivity of the two types of the active materials is well balanced.

3. The lithium-ion secondary battery cathode according to the above item "1" or item "2" may include, for example, a configuration in which a relation of "m1:m2 = 6:4 to 8:2" is satisfied. "m1" represents mass ratio of the first lithium nickel composite oxide. "m2" represents mass ratio of the second lithium nickel composite oxide.

When the relation of "m1:m2 = 6:4 to 8:2" is satisfied, improvement in the capacity retention rate is anticipated. This is thought to be because the reactivity of the two types of the active materials is well balanced.

4. The lithium-ion secondary battery cathode according to any one of the above items "1" to "3" may include, for example, the following configuration. The first lithium nickel composite oxide is of a composition that is represented by a first composition formula of "LiNiₓCo_{y}Mn_{z}O₂". The second lithium nickel composite oxide is of a composition that is represented by a second composition formula of "LiNiᵤCoᵥMn_{w}O₂". The relations of "0.8 ≤ x < 1.0", "0 < 2y ≤ v", "0 < 3z ≤ w", "0.5 ≤ u ≤ 0.6", "0.1 ≤ v ≤ 0.2" and "0.2 ≤ w ≤ 0.3" are satisfied.

The combination of the first composition formula and the second composition formula is anticipated to improve balance of reactivity.

5. A lithium-ion secondary battery cathode for a lithium-ion secondary battery according to one aspect of the present disclosure includes a first lithium nickel composite oxide and a second lithium nickel composite oxide. The first lithium nickel composite oxide is of a composition that is represented by a first composition formula of "LiNiₓCo_{y}Mn_{z}O₂". The second lithium nickel composite oxide is of a composition that is represented by a second composition formula of "LiNiᵤCoᵥMn_{w}O₂". The relations of "0.8 ≤ x < 1.0", "0 < 2y ≤ v", "0 < 3z ≤ w", "0.5 ≤ u ≤ 0.6", "0.1 ≤ v ≤ 0.2" and "0.2 ≤ w ≤ 0.3" are satisfied. The first lithium nickel composite oxide includes first large particles and first small particles. The second lithium nickel composite oxide includes second large particles and second small particles. Relations of "H1 < H2", "h1 < h2", "H1 < h1" and "H2 < h2" are satisfied. "H1" indicates a hardness of the first large particles. "h1" indicates a hardness of the first small particles. "H2" indicates a hardness of the second large particles. "h2" indicates a hardness of the second small particles. A relation of "d1 < d2 < D1 ≤ D2" is satisfied. "D1" indicates a mean volume diameter of the first large particles. "d1" indicates a mean volume diameter of the first small particles. "D2" represents a mean volume diameter of the second large particles. "d2" represents a mean volume diameter of the second small particles. A relation of "m1:m2 = 6:4 to 8:2" is satisfied. "m1" represents a mass ratio of the first lithium nickel composite oxide. "m2" represents a mass ratio of the second lithium nickel composite oxide.

An embodiment of the present disclosure (hereinafter may be abbreviated to "present embodiment") and an example of the present disclosure (hereinafter may be abbreviated to "present example") will be described below. It should be noted, however, that the present embodiment and the present example do not limit the technical scope of the present disclosure. The present embodiment and the present example are exemplary in all respects. The present embodiment and the present example are non-limiting. The technical scope of the present disclosure encompasses all changes within the meaning and scope equivalent to the description of the claims. For example, it is planned from the beginning that optional configurations will be extracted from the present embodiment and optionally combined.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating a method for measuring particle hardness in an embodiment;

FIG. 2 is a conceptual diagram illustrating an example of a lithium-ion secondary battery according to the embodiment; and

FIG. 3 is a table showing an example of experiment results according to the embodiment.

### DETAILED DESCRIPTION OF EMBODIMENTS

### Terms and Phrases

"Comprise", "include", "have", and variations thereof are open ended expressions. A configuration expressed as open ended may or may not further include additional elements in addition to the required elements. The term "consist of" is a closed ended expression. However, even configurations that are expressed by closed ended terms can include normally-associated impurities and additional elements that are irrelevant to the pertinent technology. The term "substantially consist of" is a semi-closed ended expression. Configurations that are expressed by semi-closed ended terms allow addition of elements that do not substantially affect the basic and novel characteristics of the pertinent technology.

Geometric terms are not to be construed in a strict sense. Examples of such geometric terms include "parallel", "perpendicular", "orthogonal", and so forth. For example, directions, angles, distances, and so forth, may relatively vary within a range in which substantially the same or similar functions are obtained. The geometric terms can include tolerances, variations, and so forth regarding designing, working, manufacturing, and so forth, for example. There are cases in which dimensional relations in the drawings do not match actual dimensional relations. There are cases in which dimensional relations in the drawings are changed to facilitate understanding by the reader. For example, there are cases in which the length, width, thickness, and so forth, are changed. There are cases in which part of configurations are omitted.

Numerical ranges such as "m to n%" and so forth are inclusive ranges including their upper and lower limit values unless otherwise specified. That is to say, "m to n%" indicates the numerical range of "m% or more and n% or less." Also, "m% or more and n% or less" includes "more than m% and less than n%". The phrases "equal to or more than" and "equal to or less than" are represented by inequality signs " ≥ " and " ≤ " with equal signs. The phrases "more than" and "less than" are represented by inequality signs " > " and " < " without equal signs. A numerical value selected as desired from within a numerical range may be set as a new upper limit value or a new lower limit value. For example, a new numerical range may be set by combining as desired a numerical value within the numerical range and a numerical value shown in a different part of the present specification, in a table, in the drawings, or the like. With regard to a numerical range (interval), for example, "a range formed by any one or two endpoints selected from the group a, b, c, and d" includes "a ≤ x", "x ≤ a", "b ≤ x", "x ≤ b", "c ≤ x", "x ≤ c", "d ≤ x", "x ≤ d", "a ≤ x ≤ b", "a ≤ x ≤ c", "a ≤ x ≤ d", "b ≤ x ≤ c", "b ≤ x ≤ d", and "c ≤ x ≤ d". Any range may or may not include endpoints. That is to say, the above ranges include, for example, not only "a ≤ x" but also "a < x". The above ranges include, for example, not only "a ≤ x ≤ b" but also "a < x ≤ b", "a ≤ x < b", and "a < x < b".

Unless otherwise specified, singular terms are not limited to a singular (one) element. Singular terms also include a plurality of elements.

The "mean volume diameter" refers to a particle size at which cumulative frequency reaches 50% in volume-based particle size distribution (volume distribution). The mean volume diameter of secondary particles can be measured using a laser diffraction particle size distribution measuring device (e.g., product name "MT3000" manufactured by MicrotracBEL Corp., or the like).

The particle size distribution of primary particles indicates the mode diameter of the particle size distribution measured by small-angle X-ray scattering (SAXS). For the measurement, a multipurpose X-ray diffractometer or small-angle X-ray scattering device such as, for example, product name "SmartLab" (manufactured by Rigaku Corporation), or the like, can be used.

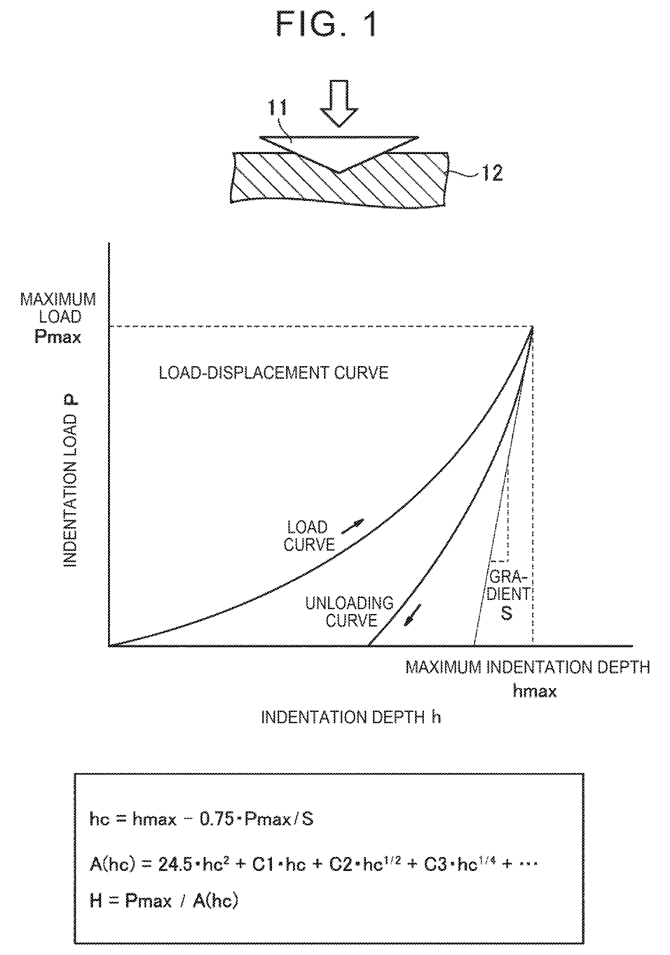

FIG. 1 is a conceptual diagram illustrating a method for measuring particle hardness in an embodiment. The hardness of the particles is measured by the following procedures. The mean volume diameter of the particles to be measured (first large particles, first small particles, second large particles, or second small particles) is identified. Five particles having a maximum Feret diameter within ±10% of the mean volume diameter are extracted from the particles (powder) to be measured. An indenter 11 is pressed into a particle 12 by a particle strength measuring instrument (e.g., a nanoindenter manufactured by Toyo Corporation, or the like), and a load-displacement curve of the particle 12 is measured. The indenter 11 is a triangular pyramidal indenter (Berkovich indenter). Hardness "H" is found by dividing a maximum load "Pmax" of the load-displacement curve by contact projected area "A(hc)". Of five measured values, the maximum value and the minimum value are excluded, and the arithmetic mean of the three values is employed.

### Lithium-Ion Secondary Battery

A lithium-ion secondary battery (hereinafter may be abbreviated as "battery") in the present embodiment includes at least one electrolyte selected from a group consisting of a liquid electrolyte, a gel electrolyte, and a solid electrolyte. The battery may be a liquid battery, a polymer battery, a solid-state battery, or an all-solid-state battery. "Solid-state battery" refers to a battery that includes a solid electrolyte. The solid-state battery may further include other electrolytes in addition to the solid electrolyte.

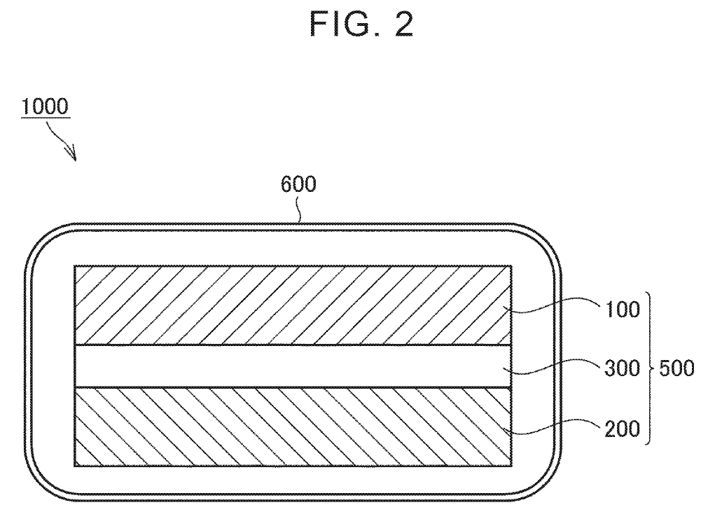

FIG. 2 is a conceptual diagram illustrating an example of a lithium-ion secondary battery according to the present embodiment. A battery 1000 may include, for example, a power generating element 500 and a case 600. The case 600 stores the power generating element 500. The case 600 may be, for example, a metal container, a pouch that is made of aluminum laminate film, or the like. The power generating element 500 may include, for example, a cathode 100, an anode 200, a separator 300, an electrolyte (omitted from illustration), and so forth. The power generating element 500 may be, for example, a wound type or a laminated type. The power generating element 500 may have a monopolar structure or may have a bipolar structure. The separator 300 can electrically separate the anode 200 from the cathode 100. The separator 300 may include, for example, a porous film or the like that is made of resin. The electrolyte is a Li ion conductor. The electrolyte may include, for example, a Li salt and an organic solvent. The separator 300 may be impregnated by the electrolyte, for example. The separator 300 may include a solid electrolyte. The electrolyte may include, for example, a polymer electrolyte, a gel electrolyte, a solid electrolyte, or the like. The solid electrolyte may include, for example, a sulfide solid electrolyte, an oxide solid electrolyte, a halide solid electrolyte, or the like. The anode 200 includes an anode active material. The anode active material is, for example, at least one selected from a group consisting of natural graphite, artificial graphite, silicon, silicon oxide, silicon-based alloys, and Si-C. "Si-C" refers to composite particles including at least one of silicon and silicon oxide, and carbon. For example, Si may be borne on a carbon material.

### Cathode

The cathode 100 includes a cathode active material. The cathode 100 may include, for example, a cathode current collector and a cathode active material layer. The cathode active material layer may be supported by the cathode current collector. The cathode active material layer may include the cathode active material. The cathode active material layer may further include a conductive material, a binder, and so forth, in addition to the cathode active material. The cathode active material layer may include, for example, by mass fraction, 0 to 10% of a conductive material, and 1 to 10% of a binder, with the remainder being the cathode active material. A range of thickness of the cathode active material layer may be, for example, a range formed by any one or two endpoints selected from a group of 10μm, 20μm, 30μm, 40μm, 50μm, 75μm, 100μm, 150μm, 200μm, 300μm, 400μm, 500μm, 750μm, and 1000μm. The range of thickness of the cathode active material layer may be, for example, "10μm or more", "1000μm or less", "10μm to 1000μm", or the like. A range of density of the cathode active material layer may be, for example, a range formed by any one or two endpoints selected from a group of 1.5 g/cm³, 2.0 g/cm³, 2.5 g/cm³, 3.0 g/cm³, 3.5 g/cm³, 4.0 g/cm³, and 4.5 g/cm³. The range of density of the cathode active material layer may be, for example, "1.5 g/cm³ or more", "4.5 g/cm³ or less", "1.5 g/cm³ to 4.5 g/cm³", or the like.

The cathode active material includes a first lithium nickel composite oxide and a second lithium nickel composite oxide. That is to say, the cathode 100 includes the first lithium nickel composite oxide and the second lithium nickel composite oxide. The first lithium nickel composite oxide has a higher Ni composition ratio than the second lithium nickel composite oxide. As long as the first lithium nickel composite oxide has a higher Ni composition ratio than the second lithium nickel composite oxide, the range of the Ni composition ratio of the first lithium nickel composite oxide and the second lithium nickel composite oxide is optional. The range of Ni composition ratio may be, for example, a range formed by any one or two endpoints selected from a group of 0.30, 0.35, 0.40, 0.45, 0.50, 0.55, 0.60, 0.65, 0.70, 0.75, 0.80, 0.85, 0.90, 0.95, and 1.00. The range of the Ni composition may be, for example, "0.30 or more", "1.00 or less", or "0.30 to 1.00."

The first lithium nickel composite oxide may be represented by, for example, a first composition formula "LiNiₓCo_{y}Mn_{z}O₂". In the first composition formula, "x" represents the Ni composition ratio described above. For example, a relation such as "0.700 ≤ x < 1.00" or the like may be satisfied. In the first composition formula, a range of "y" and "z" may be, for example, a range formed by any one or two endpoints selected from a group of 0.05, 0.10, 0.15, and 0.20. For example, the relations of "0 ≤ y ≤ 0.20", "0 ≤ z ≤ 0.20", or the like, may be satisfied. The first lithium nickel composite oxide may include, for example, LiNi_{0.8}Co_{0.1}Mn_{0.1}O₂, LiNi_{0.9}Co_{0.05}Mn_{0.05}O₂, or the like.

The second lithium nickel composite oxide may be represented by_{,} for example, a second composition formula "LiNiᵤCoᵥMn_{w}O₂". In the second composition formula, "u" represents the Ni composition ratio described above. For example, a relation such as "0.30 ≤ u ≤ 0.65" or the like may be satisfied. In the second composition formula, a range of "v" and "w" may be, for example, a range formed by any one or two endpoints selected from a group of 0.05, 0.10, 0.15, 0.20, 0.25, 0.30, and 0.35. For example, the relations of "0 ≤ v ≤ 0.35", "0 ≤ w ≤ 0.35", or the like, may be satisfied. The second lithium nickel composite oxide may include, for example, LiNi_{1/3}Co_{1/3}Mn_{1/3}O₂, LiNi_{0.4}Co_{0.3}Mn_{0.3}O₂, LiNi_{0.5}Co_{0.2}Mn_{0.3}O₂, LiNi_{0.5}Co_{0.3}Mn_{0.2}O₂, LiNi_{0.5}Co_{0.4}Mn_{0.1}O₂, LiNi_{0.5}Co_{0.1}Mn_{0.4}O₂, LiNi_{0.6}Co_{0.3}Mn_{0.1}O₂, LiNi_{0.6}Co_{0.2}Mn_{0.2}O₂, LiNi_{0.6}Co_{0.1}Mn_{0.3}O₂, or the like.

For example, the first composition formula and the second composition formula may satisfy relations such as "0.8 ≤ x < 1.0", "0 < 2y ≤ v", "0 < 3z ≤ w", "0.5 ≤ u ≤ 0.6", "0.1 ≤ v ≤ 0.2", "0.2 ≤ w ≤ 0.3", and so forth. In the first composition formula and the second composition formula, part or all of Co and Mn may be substituted with, for example, Al or the like.

A range of ratio "m1:m2" of mass ratio "m1" of the first lithium nickel composite oxide to mass ratio "m2" of the second lithium nickel composite oxide may be, for example, a range formed by a combination of any two of "1:9", "2:8", "3:7", "4:6", "5:5", "6:4", "7:3", "8:2", and "9:1". For example, a relation such as "m1:m2 = 6:4 to 8:2" or the like may be satisfied.

The first lithium nickel composite oxide includes first large particles and first small particles. The second lithium nickel composite oxide includes second large particles and second small particles. Both the large particles and the small particles may be secondary particles. The secondary particles include a plurality of primary particles. Each of the small particles may be a single particle. A single particle consists of less than 10 primary particles. A single particle may essentially consist of a single primary particle.

A range of the average number of primary particles included in each of the large particles may be, for example, a range formed by any one or two endpoints selected from a group of 50, 100, 500, 1000, 3000, 5000, and 10,000. An average number of primary particles included in each of the large particles may be in the range of, for example, "50 or more", "10,000 or less", or "50 to 10,000".

The secondary particles may have any shape. The secondary particles may be, for example, spherical, ellipsoidal, or the like. A range of circularity of the secondary particles may be, for example, a range formed by any one or two endpoints selected from a group of 0.50, 0.60, 0.70, 0.80, 0.90, 0.95, and 1.00. The range of circularity of the secondary particles may be, for example, "0.50 or more", "1.00 or less", "0.50 to 1.00", or the like.

Hardness "H1" of the first large particles and hardness "H2" of the second large particles satisfy a relation of "H1 < H2". A range of a ratio "H2/H1" may be, for example, a range formed by any one or two endpoints selected from the group of 1.2, 1.5, 2.0, 3.0, 4.0, 5.0, and 10. For example, a relation such as "1.2 ≤ H2/H1 ≤ 10" or the like may be satisfied.

Hardness "h1" of the first small particles and hardness "h2" of the second small particles satisfy a relation of "h1 < h2". A range of a ratio "h2/h1" may be, for example, a range formed by any one or two endpoints selected from a group of 1.2, 1.5, 2.0, 3.0, 4.0, 5.0, and 10. For example, a relation such as "1.2 ≤ h2/h1 ≤ 10" or the like may be satisfied.

The hardness "H1" of the first large particles and the hardness "h1" of the first small particles satisfy a relation of "H1 < h1". A range of a ratio "h1/H1" may be, for example, a range formed by any one or two endpoints selected from a group of 1.2, 1.5, 2.0, 3.0, 4.0, 5.0, and 10. For example, a relation such as "1.2 ≤ h1/H1 ≤ 10" or the like may be satisfied.

The hardness "H2" of the second large particles and the hardness "h2" of the second small particles satisfy a relation of "H2 < h2". A range of a ratio "h2/H2" may be, for example, a range formed by any one or two endpoints selected from a group of 1.2, 1.5, 2.0, 3.0, 4.0, 5.0, and 10. For example, a relation such as "1.2 ≤ h2/H2 ≤ 10" or the like may be satisfied.

For example, a mean volume diameter "D1" of the first large particles, a mean volume diameter "d1" of the first small particles, a mean volume diameter "D2" of the second large particles, and a mean volume diameter "d2" of the second small particles satisfy relations of "d1 < D1" and "d2 < D2". As long as these relations are satisfied, ranges for "D1", "d1", "D2" and "d2" may each independently be a range formed by any one or two endpoints selected from a group of, for example, 0.5μm, 1μm, 2μm, 3μm, 4μm, 5μm, 6μm, 9μm, 12μm, 15μm, 18μm, 21μm, 24μm, 27μm, and 30μm. For example, relations of "d1 < d2 < D1 ≤ D2", "d1 < d2 < D1 < D2", and so forth, may be satisfied.

Ranges of mean primary particle size of the first large particles, the first small particles, the second large particles, and the second small particles may each independently be a range formed by any one or two endpoints selected from a group of, for example, 0.01μm, 0.0 μm, 0.1μm, 0.5μm, 1μm, 1.5μm, 2μm, 2.5μm, and 3μm. The range of the mean primary particle size of the first large particles, the first small particles, the second large particles, and the second small particles may each independently be, for example, "0.01μm or more", "3μm or less", or "0.01μm to 3μm", or the like.

For example, a mean primary particle size "X1" of the first large particles, a mean primary particle size "x1" of the first small particles, a mean primary particle size "X2" of the second large particles, and a mean primary particle size "x2" of the second small particles may satisfy a relation such as "X1 ≤ x1 ≤ x2 ≤ X2" or "X1 < x1 < x2 < X2", or the like. By satisfying these relations, it is anticipated that balance of reactivity between the first lithium nickel composite oxide and the second lithium nickel composite oxide will be improved.

A range of the ratio "first large particles : first small particles" of the mass ratio of the first large particles to the mass ratio of the first small particles and a range of the ratio "second large particles : second small particles" of the mass ratio of the second large particles to the mass ratio of the second small particles may each independently be a range formed by a combination of any two of, for example, "1:9", "2:8", "3:7", "4:6", "5:5", "6:4", "7:3", "8:2", and "9:1". For example, a relation such as "first large particles: first small particles = 7:3 to 9:1" or the like may be satisfied. For example, a relation such as "second large particles: second small particles = 7:3 to 9:1" or the like may be satisfied.

The conductive material may include, for example, at least one selected from a group consisting of carbon black (acetylene black, Ketjen black "registered trademark"), flake graphite, vapor-grown carbon fibers, carbon nanotubes, and graphene flakes. A range of mean volume diameter of the conductive material may be, for example, a range formed by any one or two endpoints selected from a group of 0.5μm, 1μm, 2μm, 3μm, 4μm, 5μm, 6μm, and 9μm. The range of the mean volume diameter of the conductive material may be, for example, "0.5μm or more", "9μm or less", "0.5μm to 9μm", or the like. For example, a range of the mean volume diameter of the flake graphite may be in a range between the mean volume diameter of the first large particles and the mean volume diameter of the second small particles. It is anticipated that the flake graphite will improve balance of reactivity between large particles and small particles, due to having a size between the large particles and the small particles.

The binder may include, for example, at least one selected from a group consisting of polyvinylidene fluoride (PVdF), polytetrafluoroethylene (PTFE), polyacrylic acid (PAA), carboxymethyl cellulose (CMC), and styrene butadiene rubber (SBR).

### No. 1

Synthesis of the first lithium nickel composite oxide (LiNi_{0.8}Co_{0.1}Mn_{0.1}O₂).

A raw material aqueous solution is formed by dissolving NiSO₄, CoSO₄, and MnSO₄ in ion-exchanged water such that a molar ratio is "Ni:Co:Mn = 8:1:1". The concentration of the raw material aqueous solution is 30% by mass fraction.

A predetermined amount of NH₃ aqueous solution is placed in a reaction vessel. While the NH₃ aqueous solution is being stirred with a stirrer, the atmosphere inside the reaction vessel is substituted with nitrogen. A predetermined amount of NaOH is placed in the reaction vessel to adjust the pH to alkaline. The raw material aqueous solution and the NH₃ aqueous solution are added dropwise into a reaction vessel. The drip rate of each aqueous solution is adjusted such that pH of the reaction solution in the reaction vessel is maintained within a certain range. At this time, a precursor (transition metal hydroxide) for the first large particles is allowed to precipitate for 6 hours. A precursor for the first small particles is allowed to precipitate for 3 hours. The precursors are recovered by filtration. The precursors are washed with water. That is to say, the precursors are dispersed in ion-exchanged water using a spoon or the like. The precursors are again recovered by filtration. The precursors are dried at 120° C for 16 hours.

The precursors and a lithium compound (LiOH, Li₂CO₃, etc.) are mixed to prepare a mixture. The molar fraction of Li is adjusted to 100% to 110% with respect to the total amount of transition metal included in the precursor.

The mixture is fired in a firing furnace in an oxygen atmosphere at 700° C to 1100° C for 10 hours to obtain a fired product. The fired product is crushed by a jet mill, thereby adjusting the particle size of the secondary particles. Thus, the first large particles and the first small particles of the first lithium nickel composite oxide are prepared.

Synthesis of second lithium nickel composite oxide (LiNi_{0.5}Co_{0.2}Mn_{0.3}O₂).

A raw material aqueous solution is formed by dissolving NiSO₄, CoSO₄, and MnSO₄ in ion-exchanged water such that a molar ratio is "Ni:Co:Mn = 5:2:3". The concentration of the raw material aqueous solution is 30% by mass fraction.

A predetermined amount of NH₃ aqueous solution is placed in a reaction vessel. While the NH₃ aqueous solution is being stirred with a stirrer, the atmosphere inside the reaction vessel is substituted with nitrogen. A predetermined amount of NaOH is placed in the reaction vessel to adjust the pH to alkaline. The raw material aqueous solution and the NH₃ aqueous solution are added dropwise into a reaction vessel. The drip rate of each aqueous solution is adjusted such that pH of the reaction solution in the reaction vessel is maintained within a certain range. At this time, a precursor for the second large particles is allowed to precipitate for 6 hours. A precursor for the second small particles is allowed to precipitate for 1 hour. The precursors are recovered by filtration. The precursors are washed with water. That is to say, the precursors are dispersed in ion-exchanged water using a spoon or the like. The precursors are again recovered by filtration. The precursors are dried at 120° C for 16 hours.

The precursors and a lithium compound (LiOH, Li₂CO₃, etc.) are mixed to prepare a mixture. The molar fraction of Li is adjusted to 100% to 110% with respect to the total amount of transition metal included in the precursor.

The mixture is fired in a firing furnace in an oxygen atmosphere at 700° C to 1100° C for 10 hours to obtain a fired product. The fired product is crushed by a jet mill, thereby adjusting the particle size of the secondary particles. Thus, the second large particles and the second small particles of the second lithium nickel composite oxide are prepared.

The first lithium nickel composite oxide and the second lithium nickel composite oxide are mixed in a mass ratio of "first lithium nickel composite oxide: second lithium nickel composite oxide = 7:3" to prepare a cathode active material.

### No. 2

A cathode active material is prepared in the same manner as in No. 1, except that the hardness of each particle is changed by changing the amount of the Li compound charged, the firing temperature, and so forth.

### Evaluation

A cylindrical lithium-ion secondary battery (evaluation cell) is fabricated. The evaluation cell has the following configuration.

Power generating element: wound type

Cathode: cathode active material / AB / PVDF = 88/10/2 (mass ratio)

Anode: anode active material (natural graphite), CMC, SBR

### Electrolyte: LiPF₆ (1 mol/L), EC/DMC/EMC = 3/4/3 (volume ratio)

The cathode and the anode are each produced by applying a slurry thereof to the surface of a substrate (metal foil). A film applicator (with a film thickness control function) manufactured by Allgood Co., Ltd. is used as a coating device. After applying the slurry, the coating is dried at 80° C for 5 minutes.

Initial capacity of the evaluation cell is measured. After measuring the initial capacity, 100 charge-discharge cycles are carried out. The post cycling capacity of the evaluation cell is measured. The capacity retention rate is found by dividing the post cycling capacity by the initial capacity.

### Results

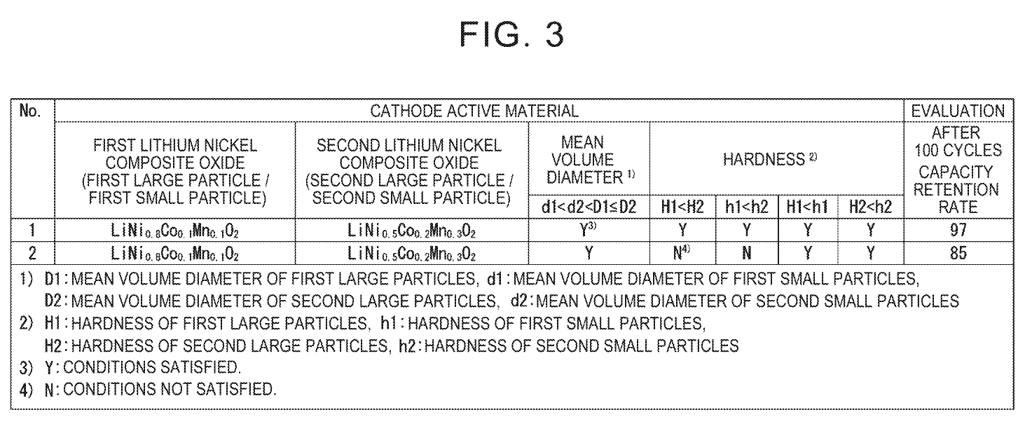

FIG. 3 is a table showing an example of experiment results according to the embodiment. No. 1 has an improved capacity retention rate as compared to No. 2. In No. 1, the hardness of the first large particles, the first small particles, the second large particles, and the second small particles satisfy the relations of "H1 < H2, h1 < h2, H1 < h1, and H2 < h2". No. 2 does not satisfy the same relations.

What is claimed is:

1. A lithium-ion secondary battery cathode comprising:
a first lithium nickel composite oxide; and a second lithium nickel composite oxide, wherein
a nickel composition ratio of the first lithium nickel composite oxide is higher than a nickel composition ratio of the second lithium nickel composite oxide,
the first lithium nickel composite oxide includes first large particles and first small particles,
the second lithium nickel composite oxide includes second large particles and second small particles,
relations of H1 < H2, h1 < h2, H1 < h1, and H2 < h2
are satisfied, where
H1 represents a hardness of the first large particles,
h1 represents a hardness of the first small particles,
H2 represents a hardness of the second large particles, and
h2 represents a hardness of the second small particles.

2. The lithium-ion secondary battery cathode according to claim 1, wherein
a relation of d1 < d2 < D1 ≤ D2
is satisfied, where
D1 represents a mean volume diameter of the first large particles,
d1 represents a mean volume diameter of the first small particles,
D2 represents a mean volume diameter of the second large particles, and
d2 represents the mean volume diameter of the second small particles.

3. The lithium-ion secondary battery cathode according to claim 1, wherein
a relation of m1:m2 = 6:4 to 8:2
is satisfied, where
m1 represents a mass ratio of the first lithium nickel composite oxide, and
m2 represents a mass ratio of the second lithium nickel composite oxide.

4. The lithium-ion secondary battery cathode according to claim 1, wherein
the first lithium nickel composite oxide is of a composition that is represented by a first composition formula of LiNiₓCo_{y}Mn_{z}O₂ and
the second lithium nickel composite oxide is of a composition that is represented by a second composition formula of LiNiᵤCoᵥMn_{w}O₂
where relations of 0.8 ≤ x < 1.0, 0 < 2y ≤ v, 0 < 3z ≤ w,
0.5 ≤ u ≤ 0.6, 0.1 ≤ v ≤ 0.2, and 0.2 ≤ w ≤ 0.3
are satisfied.

5. A lithium-ion secondary battery cathode comprising:
a first lithium nickel composite oxide; and a second lithium nickel composite oxide, wherein
the first lithium nickel composite oxide is of a composition that is represented by a first composition formula of LiNiₓCo_{y}Mn_{z}O₂ and
the second lithium nickel composite oxide is of a composition that is represented by a second composition formula of LiNiᵤCoᵥMn_{w}O₂
where relations of 0.8 ≤ x < 1.0, 0 < 2y ≤ v, 0 < 3z ≤ w,
0. ≤ u ≤ 0.6, 0.1 ≤ v ≤ 0.2, and 0.2 ≤ w ≤ 0.3
are satisfied,
the first lithium nickel composite oxide includes first large particles and first small particles,
the second lithium nickel composite oxide includes second large particles and second small particles,
relations of H1 < H2, h1 < h2, H1 < h1, and H2 < h2
are satisfied, where
H1 represents a hardness of the first large particles,
h1 represents a hardness of the first small particles,
H2 represents a hardness of the second large particles,
h2 represents a hardness of the second small particles,
a relation of d1 < d2 < D1 ≤ D2
is satisfied, where
D1 represents a mean volume diameter of the first large particles,
d1 represents a mean volume diameter of the first small particles,
D2 represents a mean volume diameter of the second large particles,
d2 represents a mean volume diameter of the second small particles, and
a relation of m1:m2 = 6:4 to 8:2
is satisfied, where
m1 represents a mass ratio of the first lithium nickel composite oxide, and
m2 represents a mass ratio of the second lithium nickel composite oxide.
